(19) United States
(12) Patent Application Publication
(10) Pub. No.: US 2021/0164285 A1
(43) Pub. Date: Jun. 3, 2021

(54) Insulating Glass Elements for Multi-Pane Doors with Transparent Edge Seal and Process for Manufacturing Insulating Glass Elements

(71) Applicants: Dieter Pfaltz, Grossdittmannsdorf (DE); Christoph Möllers, Dresden (DE)

(72) Inventor: Dieter Pfaltz, Grossdittmannsdorf (DE)

(21) Appl. No.: 15/734,234

(22) PCT Filed: Jun. 5, 2019
(86) PCT No.: PCT/IB2019/000661

§ 371 Date: Dec. 2, 2020

(30) Foreign Application Priority Data
Jun. 3, 2018 (DE) 10 2018 113 165.8

(51) Int. Cl. E06B 3/02; E06B 3/663

(52) U.S. Cl. CPC E06B 3/025; E06B 3/67326; E06B 3/66333

(57) ABSTRACT

The task of the invention is to create a reliable manufacturable and also universally usable multi-pane doors of refrigerated cabinets while maintaining the required stability, which is simplified in design and additional functions can be provided or can be subsequently integrated without additional effort. In addition, the manufacturing process is to be simplified.

Insulating glass element for multi-pane doors with transparent edge seal for use in shop fitting, refrigerated cabinet construction and special showcase construction, wherein glass spacers (1) are arranged between a base plate (4) and a cover plate (4) in the vertical or longitudinal edge region of the door and glass spacers (1) in the upper horizontal or transverse edge region or aluminum or plastic spacers (2) in the lower or in both horizontal or transverse edge regions and aluminum or plastic spacers (2) are arranged between the base plate (4) and the spacers (1), 2) and between the spacers (1, 2) and cover plate (4) there is a lamination layer (3) in the form of an ethylene-vinyl acetate copolymer (3), wherein the laminating layer (3) is arranged at the four corner points from the horizontal spacers (2) to the vertical spacers (1) on abutment or overlapping, wherein the vertical or longitudinal glass spacers (1) are arranged between 0.5 and 1.5 mm from the pane edge of the base pane (4) and cover pane (4), are particularly preferably set back by 1 mm and the horizontal or transverse glass spacers (1) or aluminum or plastic spacers (2) are arranged between the vertical or longitudinal glass spacers (1) or respectively above or below the transverse ends of the vertical or longitudinal glass spacers (1).

### CROSS REFERENCE TO RELATED APPLICATIONS

This application is the U.S. national stage of International Application No. PCT/IB2019/000661, filed on 2019 Jun. 5. The international application claims the priority of DE 102018113165.8 filed on 2018 Jun. 3; all applications are incorporated by reference herein in their entirety.

### BACKGROUND

Insulating glass elements for multi-pane doors with transparent edge seal for use in conservatories, shop fitting, refrigerated cabinets and special display case construction.

Insulating glass is used in the areas of refrigerated cabinets, shop fitting and special display case construction in order to be able to store food in particular and present it to customers at the same time at temperatures of 5 degree Celsius or below 5 degrees Celsius in the so-called deep-freeze range. Refrigerated shelves with glass doors are also used for this purpose. Until now, the spacers between the two glass door panes installed parallel to each other were mainly aluminum spacers based on the same principle as for insulating glazing in the building industry.

In order to achieve a tight bond between the glass pane and the spacer, a butyl cord was applied in practice using an extruder. A black compound which hardens permanently elastic. An aluminum profile is perforated towards the inside of the pane. In the cavity of the aluminum profiles there is a water-binding material, e.g. silica gel or molecular sieve. The air trapped between the two panes contains moisture, which would condense if the dew point were to fall below, as precipitation on the glass panes inside the glass laminate. The water-binding material now binds this moisture up to the maximum saturation limit of this material. If there is no new air between the two panes due to leaks in the butyl cord and the outer sealing compound, e.g. polysulphide, the risk of condensation is permanently eliminated.

Finally, the introduced aluminum profile is connected to the outside of the glass by a circumferential sealing compound. Sealing compound and butyl cord thus form a double sealing system.

Thus, in the publication DE 20 2013 012 171 U1, a refrigerator for the storage of foodstuffs is provided with an access opening which lies in a vertical plane and which can be closed by a pivotable or movable and multi-glazed refrigerator door, wherein the refrigerator door has at least two transparent glass panes which are spaced apart from one another by edge-side spacing elements, wherein a vertically transparent spacing element made of a transparent material and no supporting frame element is provided at a transparent vertical edge of the refrigerator door, the vertical transparent spacer element connecting the two glass panes to one another and holding them at a defined distance from one another, the spacer element being in the form of a hollow profile at the lower horizontal edge of the refrigerator door, the hollow profile having several openings towards the intermediate space between the glass panes, and the hollow spacer element being filled with drying agent which serves to absorb moisture from the intermediate space.

DE 11 2014 002 800 T5 reveals a glazed element for a refrigerator cabinet, with a resin-based spacer between two glass panes.

The EP 2 456 942 A1 reveals glass spacers which are glued between two glass plates.

The WO 2016/091954 A1 reveals an insulating window at least comprising two spaced glass panes for buildings, in particular for exhibition halls, public and commercial building halls, verandas and pergolas and further applications apart from a cooling device with high thermal insulation and sufficient resistance to wind and other weather influences, whereby polymethyl methacrylate is used as spacer material.

Furthermore, WO2018/054427 A1 reveals multi-pane doors of refrigerated cabinets with vertical glass spacers and horizontal aluminum profiles as spacers which are connected to the glass panes with ethylene-vinyl acetate copolymer film tapes and a process for manufacturing them. Here, the vertical glass spacers are flush with the glass plates, which is disadvantageous because the ethylene vinyl acetate copolymer between the glass plates and the glass spacer emerges uncontrollably and leads to undefined results. Another disadvantage is the complicated manufacturing process. This means that during transport and insertion into the laminating oven of this composite still loose individual elements shift. In addition, the applications of multi-pane doors are very limited.

### SUMMARY

The task of the invention is to create a reliable manufacturable and also universally usable multi-pane doors of refrigerated cabinets while maintaining the required stability, which is simplified in design and additional functions can be provided or can be subsequently integrated without additional effort. In addition, the manufacturing process is to be simplified.

Insulating glass element for multi-pane doors with transparent edge seal for use in shop fitting, refrigerated cabinet construction and special showcase construction, wherein glass spacers (1) are arranged between a base plate (4) and a cover plate (4) in the vertical or longitudinal edge region of the door and glass spacers (1) in the upper horizontal or transverse edge region or aluminum or plastic spacers (2) in the lower or in both horizontal or transverse edge regions and aluminum or plastic spacers (2) are arranged between the base plate (4) and the spacers (1), 2) and between the spacers (1, 2) and cover plate (4) there is a lamination layer (3) in the form of an ethylene-vinyl acetate copolymer (3), wherein the laminating layer (3) is arranged at the four corner points from the horizontal spacers (2) to the vertical spacers (1) on abutment or overlapping, wherein the vertical or longitudinal glass spacers (1) are arranged between 0.5 and 1.5 mm from the pane edge of the base pane (4) and cover pane (4), are particularly preferably set back by 1 mm and the horizontal or transverse glass spacers (1) or aluminum or plastic spacers (2) are arranged between the vertical or longitudinal glass spacers (1) or respectively above or below the transverse ends of the vertical or longitudinal glass spacers (1). FIG. 1

### DETAILED DESCRIPTION

The task of the invention is to create reliable manufacturable and also universally usable multi-pane doors of refrigerated cabinets while maintaining the required stability, which is simplified in design and additional functions can be provided or can be subsequently integrated without additional effort. In addition, the manufacturing process is to be simplified.

With the insulating glass element according to the invention, it is possible to create multi-pane doors with a transparent edge seal in the specified application for use in conservatories, shop fitting, refrigerated display cabinets and special showcase construction, wherein glass spacers are arranged between a base pane and a cover pane in the vertical or longitudinal edge region of the door and glass spacers are arranged in the upper horizontal or transverse edge region, or aluminum or plastic spacers are arranged in the lower or in both horizontal or transverse edge regions, and a laminating layer in the form of an ethylene-vinyl acetate copolymer is present between the base pane and the spacers and between the spacers and cover pane, wherein the laminating layer is arranged at the four corner points from the horizontal spacers to the vertical spacers in abutting or overlapping relationship, wherein the vertical or longitudinal glass spacers from the pane edge of the base pane and cover pane are between 0.5 and 1.5 mm, are particularly preferably set back by 1 mm and the horizontal or transverse glass spacers or aluminum or plastic spacers are arranged between the vertical or longitudinal glass spacers or respectively above or below the transverse ends of the vertical or longitudinal glass spacers. This ensures a defined and clean closure and projection of the ethylene-vinyl acetate copolymer emerging between the glass spacers or aluminum or plastic spacers and the base pane and the cover pane at the edge of the pane and in the space between the panes, whereby the ethylene-vinyl acetate copolymer at the pane edge does not project beyond the pane edge. This means that the insulating glass elements can be set down or stored or transported on all outer edges. There is no need for time-consuming reworking of the insulating glass elements due to the laborious removal of the escaping ethylene vinyl acetate copolymer.

With the process for the production of insulating glass elements according to the invention, it is achieved in this specified application that multi-pane doors with at least partially transparent edge seal are created for the areas of application shop fitting, refrigerated furniture construction and special showcase construction using an ethylene vinyl acetate copolymer lamination layer, wherein glass spacers each having an ethylene-vinyl acetate copolymer lamination layer adhering to two opposite longitudinal surfaces are placed on the base pane of the insulating glass element as a semi-finished product in the vertical or longitudinal edge region between 0.5 and 1.5 mm, particularly preferably 1 mm, from the outer vertical or longitudinal edge of the pane, in that the horizontal or transverse glass spacers or aluminum spacers or plastic spacers each having an ethylene-vinyl acetate copolymer lamination layer adhering to two opposite longitudinal surfaces are placed at right angles to the glass spacers at the vertical or longitudinal edge regions between the vertical or longitudinal glass spacers or in each case above or below the transverse ends of the vertical or longitudinal glass spacers as a semi-finished product, wherein the respective ethylene-vinyl acetate copolymer laminating layers are abutting or overlap each other, wherein the glass spacers and aluminum spacers or plastic spacers form a frame running all around, that the cover pane is placed on this frame, wherein the frame running all around forms therewith a pane space between the base pane and the cover pane, and the entire composite is clamped, for example with foldback clamps, and subsequently the laminating process is carried out at approximately 135 degrees Celsius in the laminating oven, thus enabling a simple and reliable process, since the few individual components, the respective spacers and the glass panes require only a few manual operations and, in addition, basic stability is already achieved when these individual components are arranged, which enables high-precision work and thus the production of high-quality insulating glass elements, in which, in addition, the ethylene-vinyl acetate copolymer laminating layer, which is liquefied by lamination and protrudes from the space between the spacers and the glass panes, does not protrude beyond the edge of the pane after lamination, thus eliminating the need for time-consuming reworking.

Spacers are understood to be glass spacers or aluminum spacers or plastic spacers or a selection thereof, whereby, depending on the position in relation to the glass panes, it is possible to infer the concrete type and designation of the concrete type(s) and designation of the spacers. The grouping into spacers is done where a separation of the terms does not seem necessary. It is also common to refer to the respective distance elements as spacers, for example as glass spacers or aluminum spacers or plastic spacers.

The grouping into glass panes includes the base pane and the cover pane, provided that a separation of the terms does not appear necessary.

Insulating glass panes and insulating glass elements are in this respect equivalent. To simplify matters, the text mainly uses insulating glass elements.

However, only plastics or corresponding plastic mixtures that are temperature-resistant can be used as plastic spacers. This includes temperature resistance, for example with regard to shape, size, color, transparency, structure and strength. Additional criteria are added as required.

As an abbreviation of the term ethylene-vinyl acetate copolymer, EVA is also used and should be understood as synonymous. Ethylene-vinyl acetate copolymer or EVA may be present as film or granulate and in each case forms a laminating layer.

Advantageous designs of the invention are presented in the sub-claims.

The connection between the glass spacers, preferably a soda-lime glass rod, and the two glass panes is made by means of a laminating layer, preferably with ethylene-vinyl acetate copolymer in film form or granulate form by lamination. This creates a permanent bond and at the same time prevents a cold bridge.

The composite is based on crystal-clear three-dimensional cross-linking. The use of such glass doors in deep-freeze areas is possible without any problems. There is no condensation due to the temperature falling below the dew point. The type of cross-linking of the copolymer with the glass reliably excludes delamination, penetration of moisture and detachment phenomena between copolymer and glass.

By grinding the glass spacers and having a polished breaking edge with a 0.5 mm seam, cross-linking with the laminating coating is promoted with the respective spacers and the two glass panes and the laterally emerging laminating coating is distributed evenly along the seam without protruding or jotting over in an undefined manner.

Advantageously used as an ethylene-vinyl acetate copolymer laminating layer for the spacers and between the glass sheets and the spacers as a film or as a multiple cross-linking agent in granular form as a result of the heating during lamination in liquid form, whereby the joints between the respective spacers and the two glass sheets are completely filled with the laminating layer during lamination and complete cross-linking at the joints is promoted.

The fact that the laminating layer in the form of an ethylene-vinyl acetate copolymer in the form of the film has a thickness of 0.38 mm or a multiple of this thickness favors easy processing and also full and complete cross-linking at the joints between the spacers and the glass panes.

By sealing the ends of the aluminum or plastic spacers with butyl or the ethylene vinyl acetate copolymer lamination layer, leakage can be further reduced. In addition, this also ensures more reliably that the desiccant to be filled in later cannot escape from the ends of the aluminum or plastic spacers.

It is advantageous to have butyl or the ethylene-vinyl acetate copolymer lamination layer in the spaces or joints between the horizontal or transverse aluminum or plastic spacers and the vertical or longitudinal glass spacers, or the ethylene-vinyl acetate copolymer lamination layer in the spaces or joints between the glass spacers, further increasing the leak tightness. The use of the ethylene vinyl acetate copolymer laminating layer alone or in combination also avoids boundary layers or mixing at the interface between the butyl and the ethylene vinyl acetate copolymer laminating layer. It is advantageous to use only one material for cross-linking to connect the respective spacers to the glass panes.

By placing the horizontal or transverse glass spacers or aluminum spacers or plastic spacers, each with a butyl layer or ethylene-vinyl acetate copolymer lamination layer adhered to two opposite longitudinal surfaces, as a semi-finished product between the vertical or longitudinal glass spacers between 3 mm and 15 mm or 16 and 40 mm from the edge of the pane, set back on the base pane, further extensions or installations in the open space between the glass panes or other constructive measures can be made at the horizontal or transverse ends of the insulating glass element.

By arranging the vertical or longitudinal glass spacers on the insulating glass elements, each with an ethylene-vinyl acetate copolymer laminating layer adhering to two opposite longitudinal surfaces, as a semi-finished product with their transverse ends at least between 0.5 and 1.5 mm, particularly preferably 1 mm, from the horizontal or transverse edge of the pane on the base pane, the stability at the respective horizontal or transverse ends of the insulating glass element is increased.

By arranging the horizontal or transverse glass spacers or aluminum spacers or plastic spacers as a semi-finished product with a butyl layer or ethylene-vinyl acetate copolymer lamination layer adhered to two opposite longitudinal surfaces each above or below the transverse ends of the vertical or longitudinal glass spacers or between the vertical or longitudinal glass spacers between 3 mm and 40 mm from the horizontal or transverse edge of the pane and set back onto the base pane, wherein the respective transverse ends of the vertical or longitudinal glass spacers are arranged so as to reach up to horizontal or transverse glass spacers or aluminum spacers or plastic spacers or up to a maximum of the side of the horizontal or transverse glass spacers or aluminum spacers or plastic spacers facing the horizontal or transverse edge of the pane, further attachments or installations can also be made at the horizontal or transverse ends of the insulating glass element in the open space between the glass panes or other constructive measures, whereby the vertical or longitudinal glass spacers do not impede a lateral mounting or arrangement or the lateral removal of the attachments or installations from the open space between the glass panes or other constructive measures, since the vertical or longitudinal glass spacers end correspondingly beforehand.

In the area between the horizontal or transverse glass spacers or aluminum spacers or plastic spacers and the horizontal or transverse edge of the pane, functional elements or retaining elements or construction elements are available or can be used to advantage, whereby, for example, door hinge parts or hinge receptacles or also or additionally lighting, for example to illuminate the floor or the goods or sensor technology, for example to control the lighting or to detect the position of the door to indicate that it has been opened for too long. Energy sources such as accumulators or batteries can also be accommodated in this area.

By placing the horizontal or transverse glass spacers or aluminum spacers or plastic spacers, each with a butyl layer or ethylene-vinyl acetate copolymer lamination layer adhered to two opposite longitudinal surfaces, as a semi-finished product between the vertical or longitudinal glass spacers between 3 mm and 15 mm or 16 and 40 mm from the edge of the pane, set back on the base pane, further extensions or installations in the open space between the glass panes or other constructive measures can be made at the horizontal or transverse ends of the insulating glass element.

In a further development of the process, the vertical or longitudinal glass spacers, each with an ethylene-vinyl acetate copolymer lamination layer adhering to two opposite longitudinal surfaces, are placed on the base pane with their transverse ends at least between 0.5 and 1.5 mm, particularly preferably 1 mm, from the horizontal or transverse edge of the pane, whereby even at the transverse ends of the vertical or longitudinal glass spacers, the extruded ethylene-vinyl acetate copolymer lamination layer does not protrude beyond the edge of the pane after lamination, thus likewise eliminating the need for time-consuming reworking, and furthermore, it is possible to place the insulating glass elements on the horizontal or transverse edge of the pane without pressing in or destroying the extruded ethylene-vinyl acetate copolymer lamination layer.

By placing the horizontal or transverse glass spacers or aluminum spacers or plastic spacers, each with an ethylene-vinyl acetate copolymer laminating layer adhered to two opposite longitudinal surfaces, as a semi-finished product above or below the transverse ends of the vertical or longitudinal glass spacers or between the vertical or longitudinal glass spacers between 3 mm and 40 mm from the horizontal or transverse edge of the pane, set back onto the base pane, wherein the respective transverse ends of the vertical or longitudinal glass spacers are arranged so as to reach up to horizontal or transverse glass spacers or aluminum spacers or plastic spacers or up to a maximum of the side of the horizontal or transverse glass spacers or aluminum spacers or plastic spacers facing the horizontal or transverse edge of the pane, it is achieved that over the entire width or transverse side of the insulating glass element, in addition to an additional seal, functional elements or retaining elements or construction elements can also be arranged as required.

By sealing the ends of the horizontal or transverse aluminum spacers or plastic spacers with butyl or an ethylene-vinyl acetate copolymer lamination layer, an increased sealing effect is achieved at their ends. The ethylene-vinyl acetate copolymer laminating layer may be an independent ethylene-vinyl acetate copolymer laminating layer or the ethylene-vinyl acetate copolymer laminating layer may be one of the respective horizontal or lateral aluminum spacers or plastic spacers.

It is also intended that in the spaces or joints between the horizontal or transverse aluminum or plastic spacers and the vertical or longitudinal glass spacers with butyl or an ethylene-vinyl acetate copolymer lamination layer is arranged or that these spaces or joints are closed with butyl or an ethylene-vinyl acetate copolymer lamination layer, thus achieving an increased sealing effect at the spaces or joints.

By using ethylene-vinyl acetate copolymer lamination layers as the only lamination material, an optimum material closure or material flow of the respective ethylene-vinyl acetate copolymer lamination layers involved is achieved. Interfaces to or mixing with other laminating materials involved in the lamination process are avoided.

The ethylene-vinyl acetate copolymer laminating layer may be an independent ethylene-vinyl acetate copolymer laminating layer or the ethylene-vinyl acetate copolymer laminating layer may be one of the respective horizontal or lateral aluminum spacers or plastic spacers.

In a further development, the ethylene-vinyl acetate copolymer lamination layer is arranged separately in the gaps or joints between the glass spacers or is folded over from the horizontal or transverse glass spacers or from the vertical or longitudinal glass spacers or aluminum spacers or plastic spacers into the joints or gaps or is laid or guided around at least one of the front ends of the vertical or longitudinal glass spacers.

It is advantageous to seal and laminate only with a material of the same chemical composition and the same coefficient of expansion.

By keeping the respective glass spacers or aluminum spacers or plastic spacers with side spacers at the respective distance from the edge of the pane, the required distances can be easily adjusted, which makes the procedure easier and more accurate.

Before further process steps or other design measures are to be carried out on the respective unit or if no further process steps or other design measures are required, the space between the panes of the insulating glass element is filled with a noble gas, preferably argon, after the lamination process has been completed in the conventional manner. Furthermore, the edges of the aluminum spacers or plastic spacers are sealed to ensure tightness, especially with regard to the valves for gas filling and with regard to the filling opening for the desiccant.

By inserting and/or mounting or gluing functional elements or holding elements or construction elements in the area between the edge seal and the horizontal or transverse edge of the pane after the edge sealing of the aluminum spacer or plastic spacer, the not yet laminated or not yet filled and not sealed insulating glass element as well as the process for its manufacture remain unaffected by the mounting or arrangement of functional elements or holding elements or construction elements. Negative influences, e.g. due to thermal stresses or thermal influences are avoided. Examples of how the invention can be implemented with the technical details are explained in more detail in the drawings.

### BRIEF DESCRIPTION OF THE DRAWINGS

The following is shown:

FIG. 1 The top view of a cut-out of an insulating glass element,

FIG. 2 The side view of a cut-out of the horizontal or transverse edge of a pane of insulating glass with aluminum spacer,

FIG. 3 The top view of a section of a corner of an insulating glass element.

FIG. 4 is a side view of a section of the vertical or longitudinal edge area of an insulating glass element with glass spacer,

FIG. 5 The side view of a cut-out of the horizontal or transverse edge of a pane of insulating glass with aluminum spacer,

FIG. 6 and FIG. 7 each one side spacer and

FIG. 8 A mounting frame in top view and side view.

### DETAILED DESCRIPTION OF THE PREFERRED EMBODIMENTS

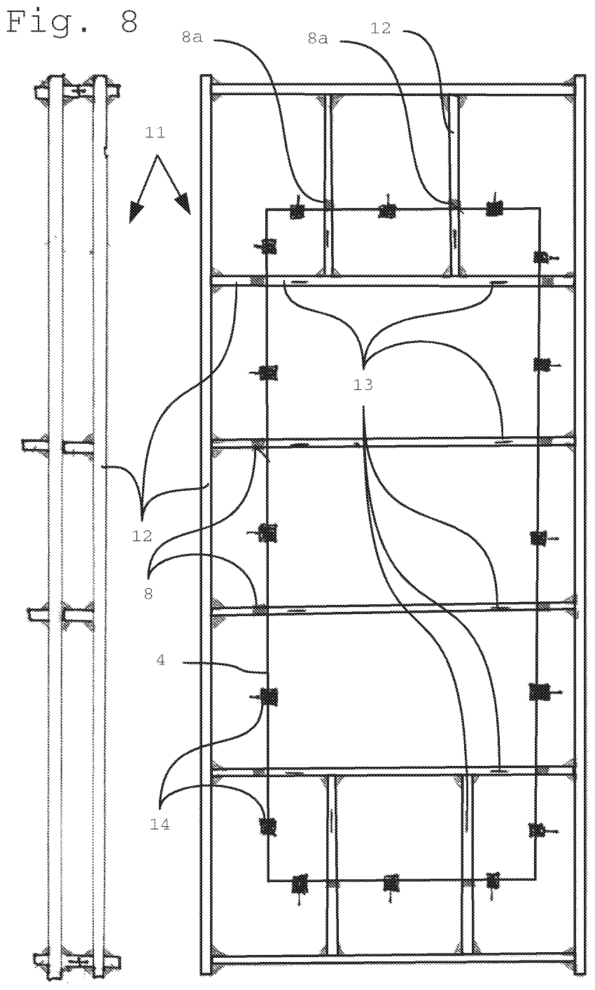

A reusable mounting frame 11 made of lightweight aluminum profiles is used to manufacture the insulating glass element in accordance with the invention. The base pane 4, the glass spacers 1 for the vertical or longitudinal edge area and glass spacers 1 or aluminum spacers 2 or plastic spacers 2 for the horizontal or transverse edge area and the cover pane 4 are placed one after the other on the mounting frame 11. The lateral distances of the glass spacers 1 or aluminum spacers 2 or plastic spacers 2 to the edge of the pane and the position of the cover pane 4 to the base pane 4 are held for and during the lamination process with side spacers 8. The side spacers 8a of a version shown in FIG. 6 hold the position of the cover plate 4 in relation to the base plate 4 so that they are congruent with each other and do not shift during the lamination process. On the other hand, side spacers 8 of a design shown in FIG. 7, in addition to the position of the cover pane 4 in relation to the base pane 4, also hold the glass spacers 1 or aluminum spacers 2 or plastic spacers 2, depending on the position of the cover pane 4 and the base pane 4, for the required distance to the edge of the pane for and during the lamination process. For this purpose, this side spacer shown in FIG. 7 has 8 stops 9 of different lengths. The stops 9 for the glass spacers 1 or aluminum spacers 2 or plastic spacers 2 project further than the stops 9 for the cover pane 4 and the base pane 4. The side spacers 8, 8a are screwed to or onto the mounting frame 11.

The mounting frame 11, as shown in FIG. 8, is placed on an assembly table before being loaded. The base plate 4 is placed in the mounting frame 11 made of aluminum profiles 12. Between the transverse aluminum profiles 12 and the glass pane 4 there is a silicone cord 13 in the aluminum profile 12 which is not pressed in all the way through and is intended to prevent scratches on the base pane 4.

On the aluminum profiles 12 of the mounting frame 11 connecting the longitudinal aluminum profiles 12 there are adjustable side spacers 8, which are shown in FIG. 7. These are pressed onto or against the edge of the base pane 4 on the long side, the side spacer 8 is fixed firmly by means of a knurled screw.

The side spacers 8a shown in FIG. 6 are fixed to the longitudinally arranged aluminum profiles 12 as sections between the transverse aluminum profiles 12 at the respective longitudinal end of the mounting frame 11. These side spacers 8a are adjustably located on the longitudinally arranged aluminum profiles 12 as sections.

These side spacers 8, 8a are used to mount the cover plate congruently on the base plate.

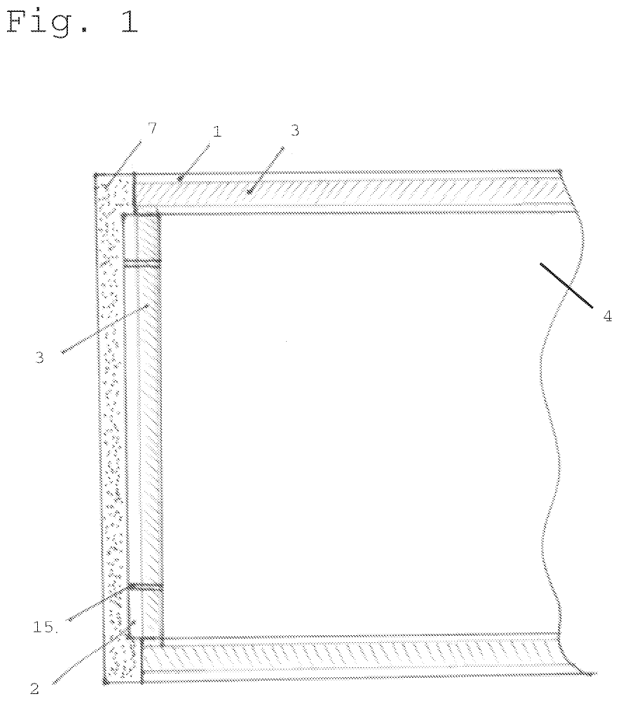

Then the first glass spacer 1 is placed on the base plate 4. For this purpose, the glass spacer 1 with adherent or fixed ethylene-vinyl acetate copolymer lamination layer 3 in the form of EVA film strips 3 is placed as a semi-finished product on the base pane 4 and simultaneously pressed against the side spacers 8 on the long side. As shown in FIG. 7, the stop 9, which is located centrally on the side spacer 8, is 1.0 mm larger in depth than the remaining stops 9 in the corners for the base and cover plate 7. This ensures that the glass spacer 1 cannot be placed flush with the edge of the base and cover pane 4. The glass spacer 1 is thus mounted 1.0 mm from the edge of the pane. The two ends of the glass spacers 1 are also set back by a few millimeters on the base plate, as shown in FIG. 1. This is necessary because at the end of the installation of the insulating glass pane, a sealant is applied parallel to the aluminum profile with polysulphide.

Analogous to the installation of the first glass spacer 1, the second glass spacer 1 is placed on the opposite long side of the base pane 4.

The aluminum spacers 2 as a semi-finished product with adhering or fixed EVA film strips 3 as an ethylene-vinyl acetate copolymer lamination layer 3 are now placed back from the edge of the pane on the base pane 1 in the process of further insulating glass element assembly, between the two glass spacers 1 laid on the long sides, as shown in FIG. 1. An optional installation would be to place the aluminum spacers 2 below the ends of the glass spacers 1, as shown in FIG. 3. Decisive for both mounting options is at least the touching or overlapping of the EVA foil strips 3 of the glass spacers 1 and the aluminum spacers 2 at the respective right-angled corners. During the subsequent thermal treatment of laminating and the resulting cross-linking of the EVA film 3, the respective ends fuse in the viscous phase at approx. 130 degrees Celsius to 135 degrees Celsius and thus come to a solid material bond within one type of material, namely the ethylene vinyl acetate copolymer laminating layer 3.

After placing the cover plate 4, congruent with the base plate 4, the assembly of the insulating glass element has progressed so far that the side spacers 8 are flush with the edges of the base and cover plate 4 and are locked there by means of the knurled screws. The final step of the installation in the mounting frame 11 before laminating is to apply clamps 14, preferably with foldback clamps 14.

The mounting frames are then placed horizontally on top of each other on undercarriages with a distance of 60-90 mm. In this way, 15-20 mounting frames can be laminated on top of each other depending on the type of laminating oven. The panes are then moved into a laminating oven, preferably a convection oven. After a warm-up phase of up to approx. 80 degrees Celsius and a hold time of 15 minutes, the temperature is then increased to 130-135 degrees Celsius and maintained between 60-90 minutes. During this time, the EVA film 3 is cross-linked three times and forms a permanently strong bond with the respective glass and aluminum.

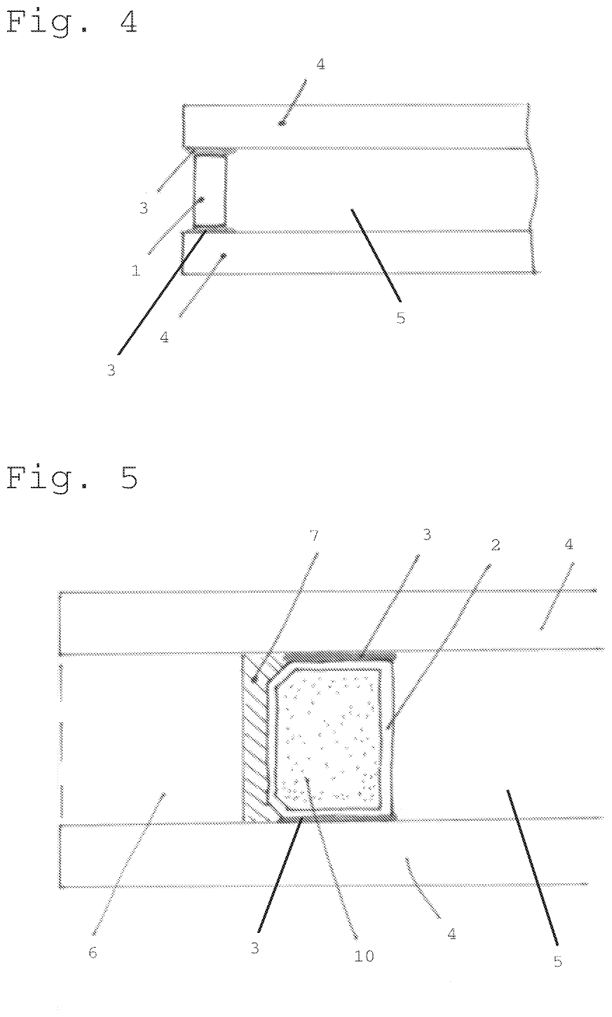

After completion of the cross-linking and cooling of the insulating glass pane or insulating glass element, the quality of the cross-linking of the EVA film 3 with the glass is examined. FIG. 4 shows the typical picture here. The EVA film 3 is bubble-free and absolutely transparent. By pressing on the applied clamps 14, the glass panes 4 are pressed together. The EVA film 3, which is viscous at 130-135 degrees Celsius, comes under pressure and swells about 1 mm into the space between the panes 5, which is intended. It is important during assembly to place the EVA film strips 3 in a straight line on the glass spacer 1 or the aluminum spacer 1, which must already be taken into account when manufacturing the glass spacer 1 or the aluminum spacer 1 with ethylene vinyl acetate copolymer lamination layer 3 as a semi-finished product. This guarantees later that the compressed EVA film 3 will form a straight line in and on the product. The bulging of the EVA film 3 to the outside is also intentional, but must not extend beyond the edge of the pane. Before filling the space between the panes 5 with noble gas, preferably argon, and the edge sealant 7 which is still to be applied, the pane must be absolutely cold so that the bead of the EVA film 3 is not damaged.

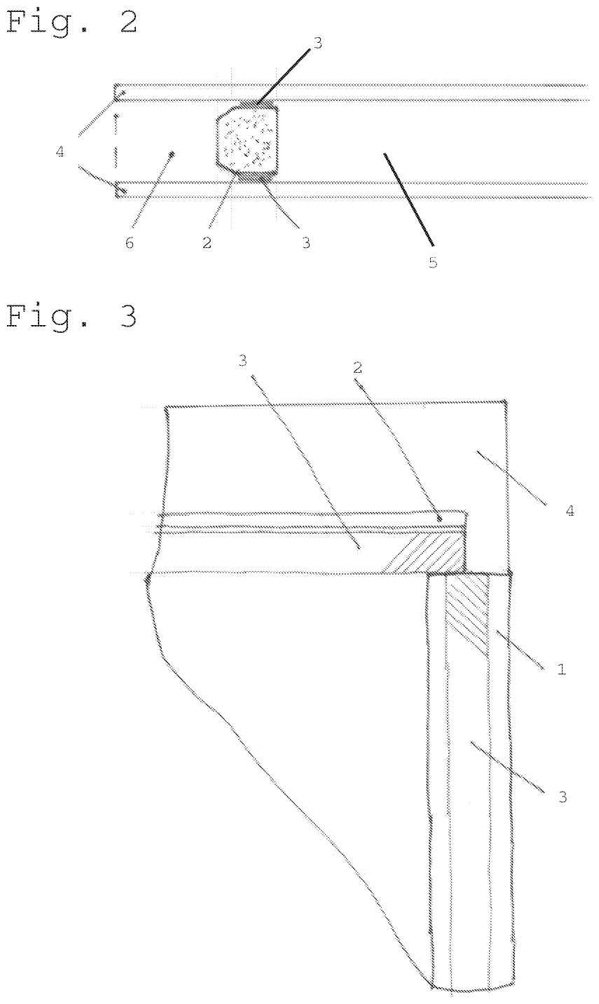

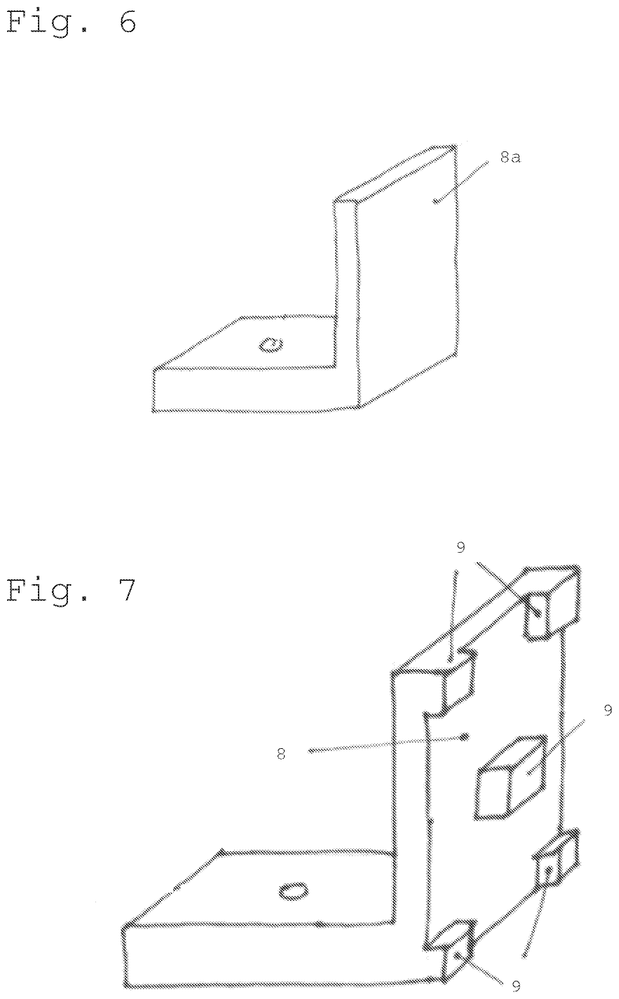

The construction with recessed aluminum spacer 2, as shown in FIG. 2, is carried out in the same way as the described installation steps. However, the aluminum spacer 2 is set back by approx. 20-30 mm during assembly in order to accommodate technical equipment in the area 6 shown in FIG. 5 as the free space gained. These can be fittings for revolving doors, lighting, accumulators or similar things.

The aluminum spacers 2 are installed at least horizontally in the bottom of the insulating glass element and are provided with holes 15 for valves. These aluminum spacers 2 are filled with a desiccant such as silica gel or molecular sieve. In order to prevent the molecular sieve from escaping, the respective profile ends are provided with butyl or with an ethylene-vinyl acetate copolymer lamination layer 3, for example as an EVA film strip section, and thus sealed. The aluminum spacers 2 can also be replaced by plastic spacers 2.

If the installation is not carried out until after the pane has been fitted, a seal is required above the aluminum profile 2 to guarantee the leak tightness of the insulating glass pane. Either the sealing is done mechanically or by hand with a polysulphide or by hand with a suitable butyl tape.

The flat glass 4 used in each case can have different thicknesses and consist of different types of glass, including special technical glass, and is conventionally cut, ground and washed.

The glass spacers 1, preferably consisting of a soda lime glass, are cut and ground with a polished edge and a light seam.

For special applications, multiple composite panes can also be produced using three panes 4 and more.

The cover and base pane 4 can consist of normal float glass of different glass thicknesses. However, flat glass 4 of a different manufacturing type can also be used if the thickness tolerances permit this laminated pane.

Special flat glass with soft and hard-coated surfaces, toughened safety glass (TSG) and laminated safety glass (LSG) can also be used in this composite.

In addition to the production of flat (plane) laminated elements, it is also possible to produce elements with curved flat glass 4, e.g. cylindrical panes 4 and panes 4 with multiple radii. In these cases, the glass spacers 1 are first brought to the desired shape in a glass bending furnace by gravity bending and then inserted.

In a design example not shown, the ethylene vinyl acetate copolymer lamination layer 3 is present in the spaces or joints between the vertical or longitudinal and horizontal or transverse glass spacers 1. For this purpose, the ethylene-vinyl acetate copolymer laminating layer 3 is, for example, placed or guided by one of the longitudinal surfaces of the vertical or longitudinal glass spacers 1 around the respective front end of the respective vertical or longitudinal glass spacer 1 facing the horizontal or transverse glass spacer 1. The vinyl acetate copolymer laminating layer 3 may end in the butt joint or on the opposite longitudinal surface or may merge into this opposite longitudinal surface.

### LIST OF REFERENCE NUMERALS

1—Glass spacer, spacer, glass spacer, spacer

2—Aluminum spacer, plastic spacer, spacer, aluminum spacer, plastic spacer, spacer

3—Ethylene-vinyl acetate copolymer lamination layer, EVA film, EVA film tape, film strips, lamination layer

4—Pane, glass pane, flat glass, base pane, cover pane

5—Space between panes

6—Area

7—Edge sealing

8—Side spacer

8a—Side spacer
9—Stops

10—Desiccant

11—Mounting frame

12—Aluminum profile

13—Silicone cord

14—Clamp, foldback clamp

15—Bore

1. Insulating glass element for multi-pane doors with transparent edge seal for use in shop fitting, refrigerated cabinet construction and special showcase construction, wherein glass spacers (1) are arranged between a base plate (4) and a cover plate (4) in the vertical or longitudinal edge region of the door and glass spacers (1) in the upper horizontal or transverse edge region or aluminum or plastic spacers (2) in the lower or in both horizontal or transverse edge regions and aluminum or plastic spacers (2) are arranged between the base plate (4) and the spacers (1), 2) and between the spacers (1, 2) and cover plate (4) there is a lamination layer (3) in the form of an ethylene-vinyl acetate copolymer (3), wherein the laminating layer (3) is arranged at the four corner points from the horizontal spacers (2) to the vertical spacers (1) on abutment or overlapping, wherein the vertical or longitudinal glass spacers (1) are arranged between 0.5 and 1.5 mm from the pane edge of the base pane (4) and cover pane (4), are particularly preferably set back by 1 mm and the horizontal or transverse glass spacers (1) or aluminum or plastic spacers (2) are arranged between the vertical or longitudinal glass spacers (1) or respectively above or below the transverse ends of the vertical or longitudinal glass spacers (1).

2. Insulating glass elements according to claim 1,
characterized in
that the glass spacers (1) are preferably cut from a soda-lime glass.

3. Insulating glass elements according to claim 1,
characterized in
that the glass spacers (1) are ground and have a polished breaking edge with a seam of 0.5 mm.

4. Insulating glass elements, according to claim 1,
characterized in
that the laminating layer (3) in the form of an ethylene-vinyl acetate copolymer (3) in the form of the film has a thickness of 0.38 mm or a multiple of this thickness.

5. Insulating glass elements, according to claim 1,
characterized in
that as ethylene-vinyl acetate copolymer laminating layer (3) on the spacers (1, 2) and between the glass panes (4) and the spacers (1, 2) is used as a film or as a multiple cross-linking agent in granular form as a result of heating in liquid form.

6. Insulating glass elements, according to claim 1,
characterized in
that the ends of the aluminum or plastic spacers (2) are sealed with butyl or the ethylene-vinyl acetate copolymer lamination layer (3).

7. Insulating glass elements, according to claim 1,
characterized in
that butyl or the ethylene-vinyl acetate copolymer lamination layer (3) is present in the gaps or joints between the horizontal or transverse aluminum or plastic spacers (2) and the vertical or longitudinal glass spacers (1), or in that the ethylene-vinyl acetate copolymer lamination layer (3) is present in the gaps or joints between the glass spacers (1)

8. Insulating glass elements, according to claim 1,
characterized in
that the horizontal or transverse glass spacers (1) or aluminum spacers (2) or plastic spacers (2) each have an ethylene-vinyl acetate copolymer laminating layer (3) adhering to two opposite longitudinal surfaces as a semi-finished product are arranged between the vertical or longitudinal glass spacers (1) between 3 mm and 15 mm or 16 and 40 mm from the edge of the pane and set back onto the base pane (4).

9. Insulating glass elements, according to claim 1,
characterized in
that the vertical or longitudinal glass spacers (1) are arranged as a semi-finished product with an ethylene-vinyl acetate copolymer laminating layer (3) adhering to two opposite longitudinal surfaces, with their transverse ends at least between 0.5 and 1.5 mm, particularly preferably 1 mm, from the horizontal or transverse edge of the pane being arranged on the base pane (4).

10. Insulating glass elements according to claim 1,
characterized in
that the horizontal or transverse glass spacers (1) or aluminum spacers (2) or plastic spacers (2) are semi-finished products each with an ethylene-vinyl acetate copolymer- laminating layer (3) are arranged above or below the transverse ends of the vertical or longitudinal glass spacers (1) or between the vertical or longitudinal glass spacers (1) between 3 mm and 40 mm from the horizontal or transverse edge of the pane and set back onto the base pane (4), wherein the respective transverse ends of the vertical or longitudinal glass spacers (1) are arranged so as to reach up to the horizontal or transverse glass spacer (1) or aluminum spacer (2) or plastic spacer (2) or up to a maximum of the side of the horizontal or transverse glass spacer (1) or aluminum spacer (2) or plastic spacer (2) facing the horizontal or transverse edge of the pane.

11. Insulating glass elements, according to claim 1,
characterized in
in that functional elements or retaining elements or structural elements are present or can be inserted in the region (6) between the horizontal or transverse glass spacers (1) or aluminum spacers (2) or plastic spacers (2) and the horizontal or transverse pane edge.

12. A process for the production of insulating glass elements for multi-pane doors with at least partially transparent edge seal for use in shop fitting, refrigerated furniture construction and special showcase construction using an ethylene-vinyl acetate copolymer lamination layer,
characterized in
in that glass spacers (1) each having an ethylene-vinyl acetate copolymer laminating layer (3) adhering to two opposite longitudinal surfaces are placed on the base pane (4) of the insulating glass element as a semi-finished product in the vertical or longitudinal edge region between 0.5 and 1.5 mm, particularly preferably 1 mm, from the outer vertical or longitudinal edge of the pane, set back, that at right angles to the glass spacers (1) at the vertical or longitudinal edge regions, the horizontal or transverse glass spacers (1) or aluminum spacers (2) or plastic spacers (2) each have a butyl layer or ethylene layer adhering to two opposite longitudinal surfaces vinyl acetate copolymer laminating layer (3) as a semi-finished product is placed between the vertical or longitudinal glass spacers (1) or respectively above or below the transverse ends of the vertical or longitudinal glass spacers (1), wherein the respective ethylene-vinyl acetate copolymer laminating layers (3) lie abutting or overlap each other, wherein the glass spacers (1) and aluminum spacers (2) or plastic spacers (2) form a frame extending all round, that the cover pane (4) is placed on this frame, wherein the frame extending all round forms therewith a pane space (5) between the base pane (4) and the cover pane (4), and the entire composite is clamped and subsequently the laminating process is started at approximately 135 degrees Celsius in the laminating oven.

13. Procedure according to claim 12,
characterized in
that the horizontal or transverse glass spacers (1) or aluminum spacers (2) or plastic spacers (2) each have an ethylene-vinyl acetate copolymer laminating layer (3) adhering to two opposite longitudinal surfaces as a semi-finished product between the vertical or longitudinal glass spacers (1) between 3 mm and 15 mm or 16 and 40 mm from the edge of the pane and set back onto the base pane (4).

14. Procedure according to claim 12,
characterized in
that the vertical or longitudinal glass spacers (1) are arranged as a semi-finished product with an ethylene-vinyl acetate copolymer laminating layer (3) adhering to two opposite longitudinal surfaces, with their transverse ends at least between 0.5 and 1.5 mm, particularly preferably 1 mm, from the horizontal or transverse edge of the pane being arranged on the base pane (4).

15. Procedure according to claim 12,
characterized in
By placing the horizontal or transverse glass spacers or aluminum spacers or plastic spacers, each with an ethylene-vinyl acetate copolymer laminating layer adhered to two opposite longitudinal surfaces, as a semi-finished product above or below the transverse ends of the vertical or longitudinal glass spacers or between the vertical or longitudinal glass spacers between 3 mm and 40 mm from the horizontal or transverse edge of the pane, set back onto the base pane, wherein the respective transverse ends of the vertical or longitudinal glass spacers are arranged so as to reach up to horizontal or transverse glass spacers or aluminum spacers or plastic spacers or up to a maximum of the side of the horizontal or transverse glass spacers or aluminum spacers or plastic spacers facing the horizontal or transverse edge of the pane, it is achieved that over the entire width or transverse side of the insulating glass element, in addition to an additional seal, functional elements or retaining elements or construction elements can also be arranged as required.

16. Procedure according to claim 12,
characterized in
that the ends of the aluminum or plastic spacers (2) are sealed with butyl or the ethylene-vinyl acetate copolymer lamination layer (3).

17. Procedure according to claim 12,
characterized in
that in the spaces or joints between the horizontal or transverse aluminum or plastic spacers and the vertical or longitudinal glass spacers are placed with butyl or an ethylene-vinyl acetate copolymer lamination layer or that these spaces or joints are closed with butyl or an ethylene-vinyl acetate copolymer lamination layer increased sealing effect is achieved at the spaces or joints.

18. Procedure according to claim 12,
characterized in
that the ethylene-vinyl acetate copolymer (1) is arranged separately into the spaces or joints between the glass spacers (2). laminating layer (3) or is folded over or guided by the horizontal or transverse glass spacers (1) or by the vertical or longitudinal glass spacers (1) or by aluminum spacers (2) or plastic spacers (2) into the joints or spaces or is laid or guided around at least one of the front ends of the vertical or longitudinal glass spacers (1).

19. Procedure according to claim 12,
characterized in
that the position of the cover pane with respect to the base pane and the position of the respective glass spacers (1) or aluminum spacers (2) or plastic spacers (2) with respect to the edge of the pane are held with side spacers (8, 8a).

20. Procedure according to claim 12,
characterized in
that, after the laminating process has ended, the space (5) between the panes of the insulating glass element is filled with a noble gas in the conventional manner and the edge sealing (7) of the aluminum spacers (2) or plastic spacers (2) is carried out.

21. Procedure according to claim 12,
characterized in
that, after the edge sealing, the aluminum spacer (2) or plastic spacer (2) is inserted and/or mounted or bonded in the area (6) between the edge sealing and the horizontal or transverse pane edge, functional elements or retaining elements or structural elements are inserted and/or mounted or bonded in the region (6) between the edge sealing and the horizontal or transverse pane edge.
